(19) United States
(12) Patent Application Publication
(10) Pub. No.: US 2007/0005384 A1
(43) Pub. Date: Jan. 4, 2007

(54) Method for managing circulation of items in printed format

(75) Inventors: Steven Alan Fram, Palo Alto, CA (US); Shelley Ramara Klop, Berkeley, CA (US)

Correspondence Address: PHILIP S. JOHNSON;JOHNSON & JOHNSON, ONE JOHNSON & JOHNSON PLAZA, NEW BRUNSWICK, NJ, 08933-7003, US

(73) Assignee: BabyCenter, L.L.C., San Francisco, CA (US)

(21) Appl. No.: 11/284,363

(22) Filed: Nov. 21, 2005

Related U.S. Application Data
(60) Provisional application No. 60/691,071, filed on Jun. 16, 2005.

(51) Int. Cl. G06Q 99/00

(52) U.S. Cl. 705/1

(57) ABSTRACT

A system and method for managing circulation of magazines or other printed items. A predetermined schedule is established for distribution of sequential issues. Actual circulation of each issue is compared to inventory, advertising or other circulation commitments for each issue. Predetermined starting and ending dates for circulation of successive issues are modified. An original circulation period may be extended, e.g. to exhaust an existing inventory of pre-printed copies of a particular issue and reduce waste and corresponding costs, or to meet a circulation/advertising commitment. Alternatively, the original circulation period may be contracted so that particular issue is prematurely replaced with a subsequent issue, e.g. when an advertising commitment has been met earlier than originally planned, thereby providing an opportunity to sell and/or collect revenues on additional advertising space in a subsequent issue. Particular advantage may be realized when distributing stage-based information because such information is independent of time.

### CROSS-REFERENCE TO RELATED APPLICATION

This application claims the benefit of U.S. Provisional Patent Application No. 60/691,071, filed Jun. 16, 2005, the entire disclosure of which is hereby incorporated herein by reference.

### FIELD OF THE INVENTION

The present invention relates generally to distribution of information, and more particularly to a method for managing circulation of items in a printed format, such as magazines, e.g. for the asynchronous distribution of stage-based information.

### DISCUSSION OF THE RELATED ART

It has long been known to distribute topic-related information in printed format. By way of example, numerous magazines are currently in print that present information and advertisements focused on a particular topic, interest or theme. Such magazines are typically issued on a periodic basis, e.g. monthly or quarterly, and include time-sensitive information, e.g. an advertisement for a product that is new to the marketplace.

Such magazines are distributed synchronously, meaning that it is intended that all recipients of the magazines receive the magazines at essentially the same time, to the extent reasonably possible due to delivery schedules and variations, etc., so that, for example, all subscribers to a particular magazine receive their copies of the same May issue of the magazine on or about May 1. This ensures, for example, that the information is received by the recipients in a time-appropriate manner. Any deviation from perfect synchronicity is typically the result of error, practical necessity, etc.

More recently, it has become known in the art that it may be advantageous to deliver topical information in a manner that is asynchronous with respect to time, namely, in a stage-based manner. For example, BabyCenter, L.L.C. of San Francisco, Calif., the assignee hereof, maintains a website whereby an individual may interact with a website interface to register to receive information relating to pregnancy and parenting. For example, a mother may provide personal information, such as a baby's due date or a child's birth date, and subsequently receive periodically e-mail messages relating to pregnancy and parenting. The advertising and substantive information in each e-mail message is customized for a particular stage of the pregnancy/parenting process, e.g. the 20^{th} week of pregnancy, the 21^{st} week of pregnancy, 3 months of age, etc. Each e-mail message is delivered to a particular mother in a time-sensitive manner corresponding to the stage of pregnancy/parenting that that particular mother is currently experiencing, as determined by the personal information provided during the registration process, or subsequently as part of an update to the subscriber's profile established during registration.

Accordingly, information delivery for a particular subscriber is synchronized with the subscriber's present stage in the pregnancy/parenting process. Information delivery to multiple subscribers is asynchronous with respect to time. For example, on May 1, a pregnant woman may receive the 20^{th} week of pregnancy related e-mail message, and a mother of a 3 month old girl may receive the 3 months of age related e-mail message.

It is a characteristic of e-mail messaging that e-mail messages can be prepared very quickly and very inexpensively relative to printed materials, such as a print magazine. Unlike mass-marketed printed materials that are produced in a predetermined number well in advance of distribution in large printing runs by a professional printing organization, it is not necessary to produce e-mail messages in a predetermined number to establish an available inventory. Additional copies may be produced and transmitted almost instantaneously and at virtually no cost. Unlike printed magazines, there is no need to produce, maintain or manage an inventory of e-mail messages. If a month passes since a last version of an e-mail message, and a new advertisement would be time-appropriate, the e-mail message can be modified in a matter of minutes or hours to include the new advertisement. There is no lost inventory of the old version of the e-mail message, and there is no associated cost with changing from the old version of the e-mail message. This makes management of such e-mail messages a particularly straightforward process.

We have determined that, relative to distributing information in e-mail message format, there are certain advantages to distributing information in a printed format.

### SUMMARY OF THE INVENTION

The present invention provides a system and method for managing circulation of items in printed format, such as a newsletter, book, or printed magazine. A predetermined issue schedule is established for distribution of sequential issues. Actual circulation of each issue is compared to inventory, advertising or other circulation commitments for each issue. Predetermined starting and ending dates for circulation of successive issues are modified. An original circulation period may be extended or contracted.

The method may be applied with particular advantage to asynchronous distribution of stage-based information in printed format. In that context, stages of a process are identified that are independent of a continuum of time, though the individual stages may be related to one another in a time-wise manner. For example, the first and second trimesters of pregnancy are related to one another in time, but are themselves independent in an absolute sense from any particular date or period of a continuum of time. A customized magazine edition is prepared for each of the stages. Based upon registration information provided by a subscriber, a check is performed, preferably periodically, to presently qualify the subscriber for an edition by determining which stage presently corresponds to the subscriber, and then determining whether the subscriber's stage falls within each edition's applicable range of stages. Optionally, a subscriber may be conditionally qualified for an edition by determining a future date on which the subscriber's future stage will fall within an edition's applicable range of stages. Information is then distributed to subscribers by sending to each subscriber the physical objects that are the current magazine issue(s) of each edition for which the subscriber is presently qualified.

To allow for distribution of time-sensitive information in a time-appropriate manner, a predetermined issue schedule is established for each edition. Each issue is customized for a respective period in a continuum of time. Accordingly, for example, a 2005 issue of a particular edition (first trimester pregnancy) may include advertisements for products sold in 2005, and a 2006 issue of the same edition may include advertisements for products sold in 2006. Accordingly, in the context above, the appropriateness of issues is closely tied to a continuum of time, whereas the appropriateness of editions is decoupled from the continuum of time; instead, the appropriateness of editions is closely tied to an individual subscriber's present stage in a process.

Due to the decoupling of editions from the time spectrum, in the exemplary context above or otherwise, the circulation of issues can be managed to advantage. For example, an original circulation period may be extended. Accordingly, a particular issue of an edition can be held current for an extended period of time than previously established on a predetermined issue schedule. This may be advantageous, for example, to exhaust an existing inventory of pre-printed copies of a particular issue of a particular edition, and thus reduce waste and corresponding costs, or to fulfill a circulation/advertising commitment made to an advertiser for a particular issue or collection of issues/editions, e.g. to distribute 500,000 copies of an advertisement. Alternatively, the original circulation period may be contracted. Accordingly, a particular issue of an edition can be prematurely replaced with a subsequent issue. This may be advantageous, for example, when an advertising commitment has been met earlier than originally planned, thereby providing an opportunity to sell and/or collect revenues on additional advertising space in a subsequent issue.

### BRIEF DESCRIPTION OF THE DRAWINGS

The present invention will now be described by way of example with reference to the following drawings in which:

FIG. 1 is a flow diagram illustrating exemplary issue/edition planning for stage-based delivery of information in a printed format;

FIG. 2 is a flow diagram illustrating exemplary qualification of recipients for receipt of stage-based information delivered in a printed format;

FIG. 3 is a flow diagram illustrating exemplary distribution of stage-based information in a printed format;

FIG. 4 is a flow diagram illustrating exemplary management of circulation of individual printed format issues;

FIG. 5 is a flow diagram illustrating exemplary management of inventory of individual printed format issues;

FIG. 6 is a diagram of an exemplary a issue schedule in accordance with the present invention; and

FIG. 7 is a diagrammatic view of an exemplary computer system in accordance with the present invention.

### DETAILED DESCRIPTION

The present invention provides a system and method for asynchronously distributing stage-based information in printed format. For illustrative purposes, the present invention is described herein with reference to a printed magazine, a single copy of which is conventional in physical form and may be produced using conventional printing methods. Conventional courier, bulk shipment, mailing and other methods may be used to deliver magazines to subscribers.

The content of the magazine, subscription management, the way in which individual editions and issues of the magazine are related and managed, overall distribution scheduling, inventory planning, and circulation management differ significantly from conventional items and techniques. The methods described below may be implemented, inter alia, in a straightforward manner with specialized software using conventional programming techniques, as discussed in greater detail below.

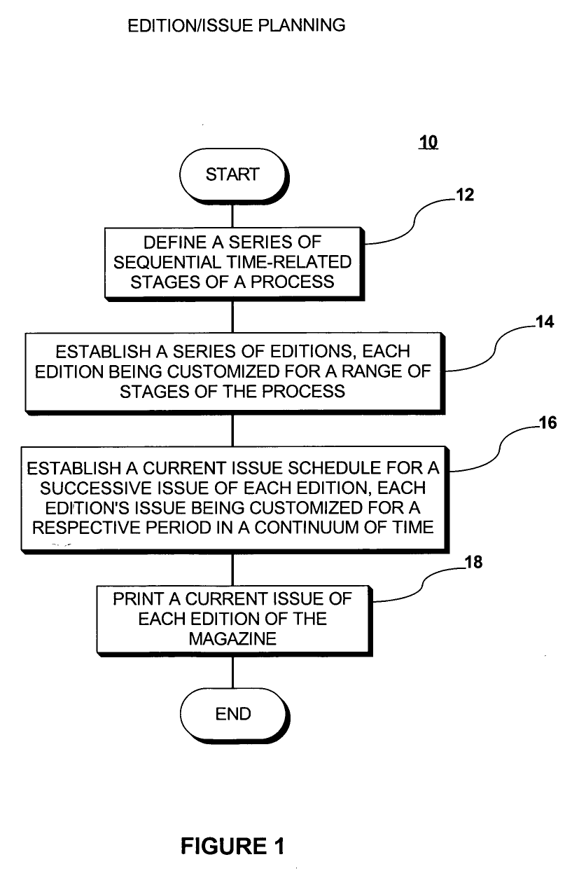

FIG. 1 is a flow diagram 10 illustrating exemplary issue/edition planning for stage-based delivery of information in a printed format, i.e. as embodied in printed physical objects, i.e. commercial print media. This flow diagram is illustrative of the way in which a topical magazine is arranged and subscriptions are managed. For illustrative purposes only, the present invention is discussed herein with reference to a printed magazine relating to the topic of parenthood, which spans pre-natal and post-natal periods. However, the present invention is applicable in a broad range of fields, including, for example, physical therapy, occupational therapy, post-injury convalescence, post-surgical convalescence, pre-wedding planning, post-wedding planning, etc. The present invention is generally applicable to any process having definable stages having characteristics that are common to many individuals among a group of individuals.

Referring now to FIG. 1, the method begins with defining of a series of sequential stages of a process, as shown at step 12. In the present example, the process is parenthood. By way of example, the sequential stages may be: (1) first week of pregnancy; (2) second week of pregnancy; (3) third week of pregnancy; . . . (41) one month old infant; (42) two month old infant; . . . etc. It will be appreciated that the stages may be defined with any desired level of granularity. For example, alternative stages may be: (1) first trimester of pregnancy; (2) second trimester of pregnancy . . . etc. It will be appreciated that the stages are defined in a manner that is independent of a continuum of time. Accordingly, the first stage (e.g., first week of pregnancy) does not correspond in an absolute sense to any particular point in a continuum of time. Instead, the first week of pregnancy stage may occur for different individuals at any particular point in a continuum of time. It is permissible, however, that the stages themselves are time-related, e.g. that the second week of pregnancy occurs one week after the first week of pregnancy. This means that the applicability of the stages over time is predictable relative to a particular date (e.g., due date).

These stages are defined in a manner such that particular information content is of greater or lesser relevance at each of the stages, so that particular information content can be delivered to a subscriber while the subscriber is at or near a particular stage at which the information is highly relevant.

For planning purposes, the process is divided into stage ranges. A series of magazine editions is then established such that each edition corresponds to a respective one of the stage ranges, as shown at step 14. Thus, the several editions of the magazine will collectively span the process. Each magazine edition will be customized to include informational articles, advertisements for products, etc. that are of particular relevance to the corresponding stage range. Each edition may be prepared in a conventional manner, e.g. using word processing and/or publishing software/tools to create a work of authorship that includes the contributions of one or more authors, editors, etc. For example, a single copy of a single edition may be a single magazine including 20 pages, 10 articles, and a variety of printed advertisements.

As a practical matter, it may be advantageous to customize each edition for a range of stages (e.g. a first edition for 0-20 weeks of pregnancy, a second edition for 21-40 weeks of pregnancy, a third edition for a child aged 0-3 months, a fourth edition for a child aged 3-6 months, etc.). In this manner, a single edition is applicable to multiple stages. This reduces the number of print runs of the magazine, mailing/delivery costs for magazines, etc. and avoids delivery latency issues related to delivery of physical objects such as printed magazines. An economic benefit, i.e. cost savings, can be achieved by reusing substantive content in sequential issues. It should be noted that as used herein, “sequential” stage ranges, issues or periods may at least partially overlap one another.

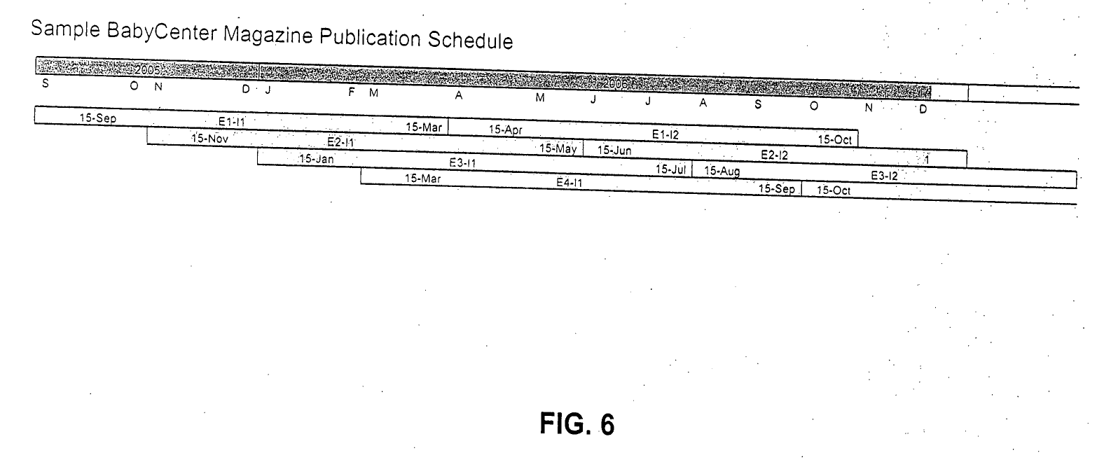

Next, an issue schedule is established for each of the several different magazine editions, as shown at step 16. Each issue represents a particular printing run of a particular edition. For example, each copy of a first issue of a particular edition may be identical in that it includes identical articles and advertisements. The second issue of the same edition may be similar in that it includes identical or similar articles and different advertisements. The issue schedule indicates a period in a continuum of time during which that issue of a particular edition is intended to be available. An exemplary current edition/issue schedule is shown in FIG. 6. In this example, the first issue (I1) of the first edition (E1) of the magazine will be considered current from Sep. 15, 2005 until Mar. 15, 2006. After that, a next issue (I2) of the first edition (E1) will be available. The later issue (I2) may include advertisements directed to the later period of time (i.e. to advertise new products), whereas the substantive articles may be similar or identical to those of the earlier edition (E1) because both issue relate to the same stage in the process. This allows the advertising content to be changed/updated relatively frequently, and the substantive content to be changed/updated relatively infrequently. The substantive articles, creative design, layout, artwork, etc. may also change from one issue to the next. The issues are preferably sequential, though they may be overlapping.

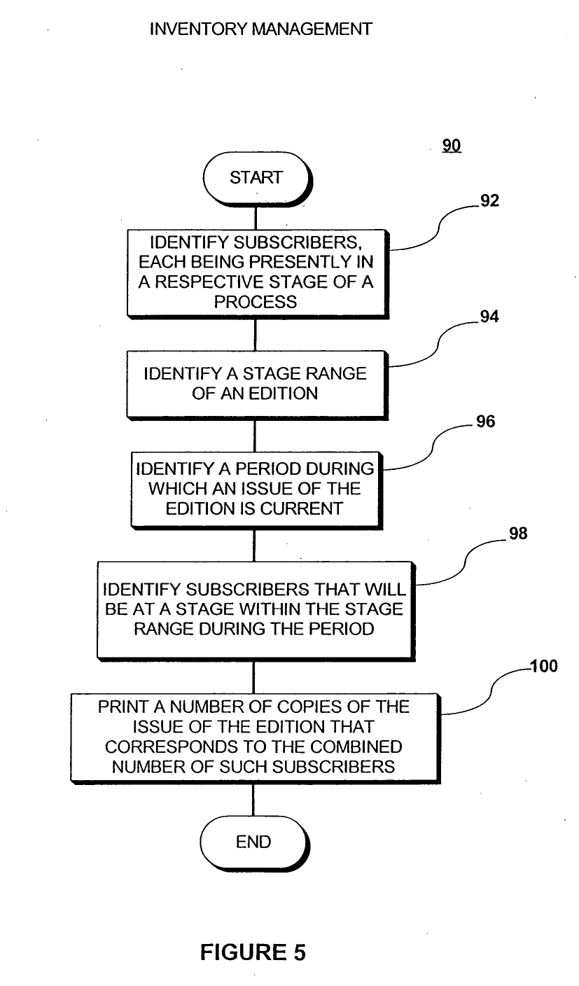

Next, an issue of each edition of the magazine is printed so that such magazines are ready for distribution, as shown at step 18. It will be noted generally, and from FIG. 6, that such issues may be printed from time to time for each edition, and need not be printed concurrently. Planning for a number of copies to print for each edition/issue is discussed in greater detail below with reference to FIG. 5. Accordingly, a plurality of distinctly different physical objects (e.g. magazines) are produced that relate to one another, and to a particular topic, in a well-defined and systematic manner. In this example, these objects are various editions of a magazine that are produced in printed form, each of the editions being customized to include content (such as articles and advertisements) that are targeted to individuals at a stage falling within a corresponding stage range. An issue of each edition is subsequently replaced with a next issue for the same edition.

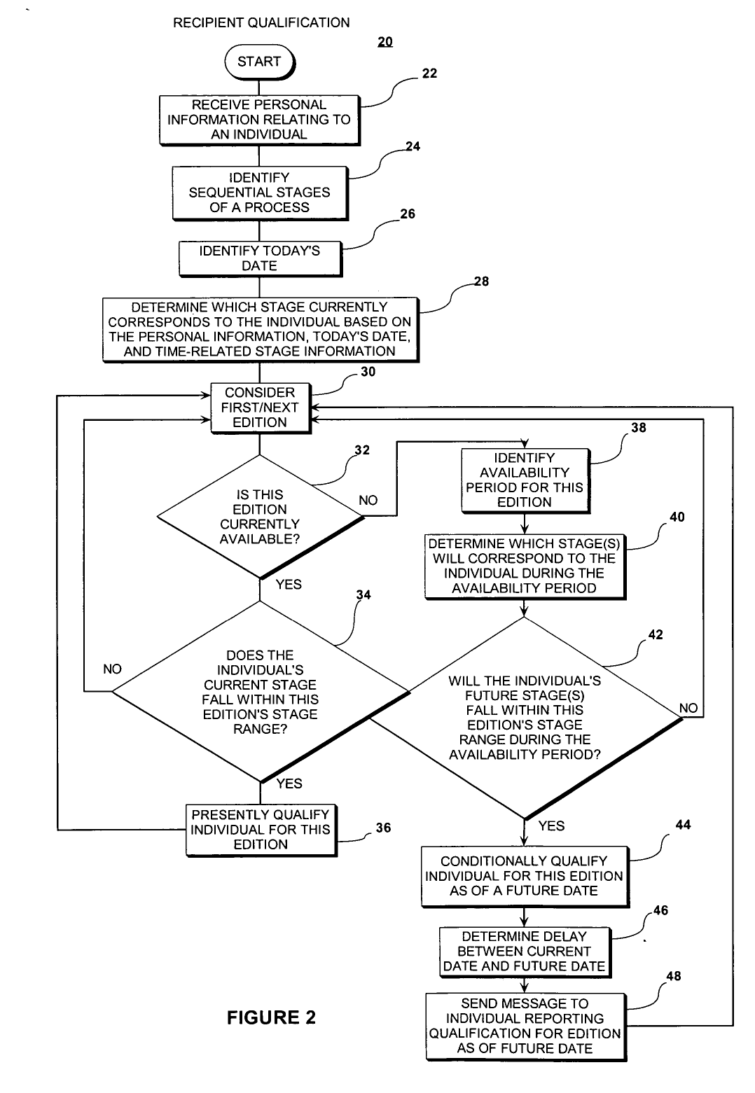

Referring now to FIG. 2, a flow diagram 20 is shown that illustrates exemplary qualification of recipients for receipt of stage-based information delivered in a printed format. The method shown begins with receipt of personal information relating to an individual, as shown at step 22. By way of example, this information may be supplied by telephone, by completing and returning a postcard, or by receiving information via a website interface. For example, such personal information may include the individual's name, mailing address, children's birth dates, and/or a due date for any pregnancy, and optionally payment/charge/billing information. Alternatively, the personal information may include a date of a different type of event when it is desired to deliver other topical information. For example, a future wedding date may be provided if the magazine is related to wedding planning/marriage, or a date of surgery may be provided if the magazine is related to planning of surgery and/or convalescence from surgery, etc. This information is used to enroll the individual as a subscriber to the magazine, and to determine which editions/issues of the magazine the subscriber should receive. By way of further example, the personal information may include information other than date information for determining a stage corresponding to the individual. For example, the personal information may include an assertion by the individual as to an applicable stage, information regarding a last completed stage in a series of sequential stages, etc. This is particularly useful when stages are sequential but not strictly defined relative to one another over time, e.g. when the time periods for each stage may vary among different individuals. Preferably, the individual may access his/her registration profile and provide updated information, e.g. revised dates, as desired.

Stages of the process are then identified, as shown at step 24. These stages are discussed above with reference step 12 of FIG. 1. In the example of FIG. 2, the current date is then identified, as shown at step 26. This is used as information for determining a currently applicable stage for the subscriber, since the subscriber has provided date information during the subscription process, and since the stages are predictably time-related. It will be appreciated that other dates, or information other than dates, may be used in alternative embodiments.

Next, it is determined which of the stages currently corresponds to the individual based on the personal information provided (either affirmatively, or in implied fashion), as shown at step 28. This is determined based upon the personal information provided, the current date, and stage information. Accordingly, if it is determined that an individual has a child with a birth date of Jun. 1, 2006, and if the current date is May 1, 2006, then the stage currently corresponding to the individual is “one month old infant” in the example above. It will be appreciated that if there is more than one applicable stage for the individual (e.g. due to multiple children, etc.), then the following process is repeated for each of the stages.

An iterative process then begins to determine whether the subscriber will qualify as a recipient of one or more of the editions. In one embodiment this is performed only for current issues of each edition. In an alternative embodiment, future issues are also considered. It is not necessary to consider past issues that are no longer available. As shown at step 30, a first edition (E1, FIG. 6) is then considered. It is next determined whether that edition is currently available, as shown at step 32. In our example, it is determined that issue 2 (I2) of E1 is available on May 1, 2006. Accordingly, it is determined whether the individual's current stage (one month old infant) falls within the presently considered edition's stage range (0-20 weeks), as shown at step 34. In this example, the subscriber would not qualify for E1 and a next edition would be considered, as shown at steps 34 and 30. When this process is repeated for the third edition (E3, child aged 0-3 months), it is determined in step 34 that the subscriber's current stage (one month old infant) falls with the presently considered edition's stage range (child aged 0-3 months) and thus the individual is presently qualified for this edition, as shown at step 36. This may involve writing an entry to a database to flag an individual subscriber as qualified for E3, I1, or to read the subscriber's mailing information and write it to an electronic mailing list file to be used for mailing E3, I1, or sending the mailing address info to a printer/publisher, etc.

This process repeats for each edition. It should be noted that a single subscriber, as the results of a single registration process and a single subscription to a single magazine, may receive multiple separate copies of a magazine. For example, a subscriber having two children may receive concurrently one magazine issue (e.g., of the first edition) for an early-stage pregnancy and a second issue (e.g., of the third edition) for a toddler. Alternatively, the subscriber may receive one issue (e.g. of the first edition) for first trimester pregnancy (1-24 weeks) and a second issue (e.g., of the second edition) for second trimester pregnancy (21-40 weeks) if the stage ranges overlap and the individual became a subscriber during the overlap period (e.g., at 22 weeks).

In the example of FIG. 2, the process also considers whether the subscriber may qualify in the future for each particular edition. Accordingly, if it is determined that a particular edition is not currently available in step 32, then an availability period for the edition is identified, as shown at step 38. For example, on Nov. 30, 2005 it would be determined that no issue of the third edition is presently available, and that the first issue of the third edition has an availability period spanning from Jan. 15, 2006 until May 15, 2006.

It is then determined which stages will correspond to the individual during the availability period, and whether the individual's future stages will fall within the edition's stage range during its availability period, as shown at steps 40 and 42. If not, then the next edition is considered, as shown at steps 42 and 30. If so, then the individual is conditionally qualified for the edition, meaning that it is noted that the individual will qualify as of a future date, as shown at step 44. Qualification may be noted in a manner similar to that described above. Since it will be desirable to send the edition to the individual only when it is stage-appropriate, a determination is made as to an appropriate amount of delay that should occur between the current date and the future date, before the issue is sent. For example, the E3 edition will be available from Jan. 15, 2006 until Jul. 15, 2006 (FIG. 6), but if the individual will enter the earliest stage of the stage range for the E3 edition on Mar. 15, 2006, then it may be determined that a delay of 3 months is required from the present date if the present date is Dec. 15, 2005.

In one embodiment, nothing further occurs, from the perspective of the subscriber, until the magazine arrives, e.g. around Mar. 15, 2006. In another embodiment, the method includes sending a message to the subscriber, e.g. an e-mail message, indicating that the subscriber will receive a particular edition on/near a particular date, as shown at step 48. For example, the subscriber may be sent an e-mail message reading “We are pleased to tell you that we will send you our Infant (0-3 month) magazine edition on Mar. 15, 2006. It's filled with articles and coupons for new parents. Watch for it in your mailbox!” Alternatively, a message may be sent to the subscriber by way of on-site messaging, e.g. to display the message on a web page screen during a web-page based registration process.

The recipient qualification method shown in FIG. 2 is preferably repeated periodically, e.g. daily, weekly, or in a manner corresponding to a frequency with which groups of magazines are mailed/sent. As will be appreciated from the method, this may mean that a single subscriber may be qualified multiple times for a single magazine. In one embodiment, the same subscriber is not reconsidered after being considered for all magazine editions. In an alternative embodiment, the same subscriber is repeatedly considered, but duplicate indications of qualification for a particular edition are deleted, or a mailing list is carefully compiled, to ensure that a particular subscriber does not receive more than one issue of any particular edition, e.g., by deleting records having duplicative mailing addresses.

Optionally, a delay period is used in connection with recipient qualification to disqualify recipients that have otherwise qualified for receipt of an edition, as shown at step 37 in FIG. 2. This is particularly useful to control inventory and/or circulation of the printed objects. For example, a recipient that has qualified for a particular edition may be subsequently requalified for the same edition (e.g. E1), or for a subsequent issue of the same edition (e.g, I2, E1), pursuant to the method above. This may result in receipt of duplicative magazines, e.g. multiple copies of the same issue/edition, or receipt of several different issues of the same edition. This may or may not be desirable. To reduce or eliminate subscribers' receipt of such duplicative magazines, a delay period may be imposed after the initial qualification, or after sending of the first magazine, to prevent resending of the same edition, or sending of the subsequent issue of the same edition, during the delay period. In other words, the method is extended such that even if qualified by the method, a particular recipient who requalifies for the same edition (either the same or a different issue) would be disqualified from receiving a duplicative magazine if a minimum delay period had not expired since the last qualification for, or sending of, a particular edition/issue. The length of the delay period may be chosen according to preference to be selectively more or less permissive of receipt of duplicative magazines. For example, for an issue schedule in which a particular issue is current for 8 months, a delay period of 1 month allows for more requalification and receipt of duplicative magazines, while a delay period of 8 months would prevent receipt of multiple copies of the same issue of any edition because the same issue will no longer be distributed after the delay period. A delay period longer than a period of time corresponding to a stage range of an edition may prevent receipt of multiple copies of that edition because the individual will no longer qualify to receive the edition after the delay period. Being more permissive of receipt of duplicative magazines tends to increase circulation for a particular issue. Being less permissive of receipt of duplicative magazines tends to conserve inventory for a particular issue.

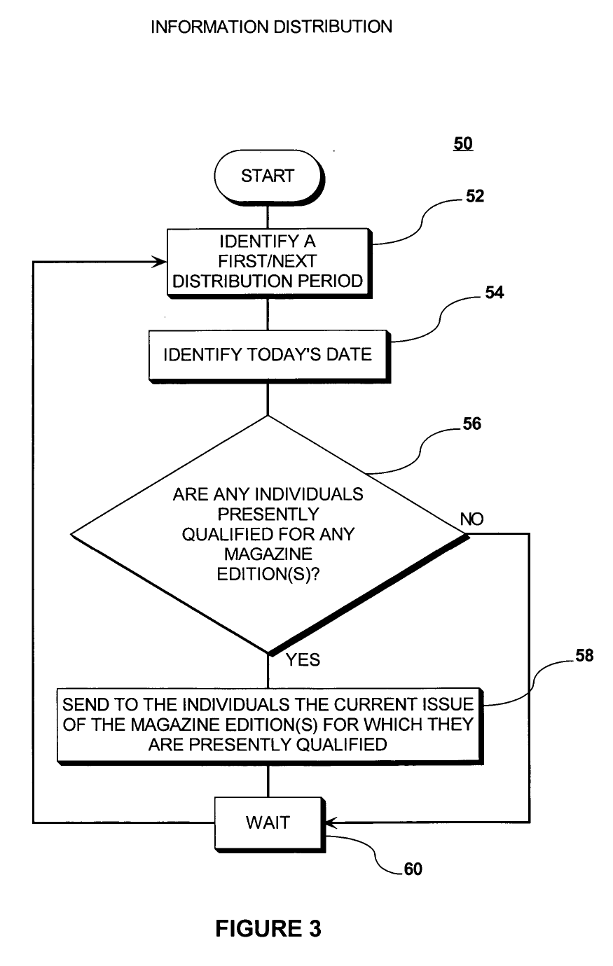

FIG. 3 is a flow diagram 50 illustrating exemplary distribution of stage-based information in a printed format. As shown in FIG. 3, the iterative method begins with identifying a first (or next) distribution period, as shown at step 52. For example, it may be determined that groups of magazines are distributed (e.g., mailed) monthly, weekly or daily, as determined by preference of the magazine publisher, distributor, etc. Next, it is determined whether there are any individuals that are presently qualified for any magazine editions based on the present date, as shown at steps 54 and 56. It is emphasized that the use of a present date is for illustrative purposes and that another date may be used, e.g. to allow for delay attributable to distribution of the magazine, etc. For example, this may be determined by referencing a database of information to which qualification information is written during the method of FIG. 2. Alternatively, this may be determined by identifying whether a mailing list has been compiled during the method of FIG. 2. Other suitable alternatives will be appreciated by those skilled in the art.

If there are no individuals that are presently qualified, then there is a wait/delay period until the process is performed again in association with a next distribution period, as shown at steps 56, 60 and 52.

If there are any individuals presently qualified for any magazine editions, then each individual is sent (e.g., mailed) the current issue of each magazine edition for which the individual is presently qualified, as shown at steps 56 and 58. Optionally, any multiple editions to be sent to a single subscriber/mailing address may be bundled and sent together to reduce shipping/distribution costs. Alternatively, such multiple editions may be sent and/or received within close proximity in time, e.g. within a one week period. Those multiple editions may be sent either in the same distribution period, or in separate distribution periods.

Accordingly, a single subscriber may receive concurrently multiple editions of a magazine (e.g., one for a first trimester fetus and another for a two year old child). This receipt of multiple editions may result from a single subscription to a single magazine, and/or from a single subscription registration process. Alternatively, a latency period may be imposed by the system to introduce a delay period between delivery of different editions of a magazine to a single subscriber, even if the subscriber presently qualifies for multiple editions. This may be advantageous, for example, to enhance the subscriber's experience by providing a sequence of new or ‘fresh’ issues over time.

It should be noted that as a result of this process, several different editions of the magazine may be sent simultaneously during a single distribution period, the editions being targeted to individuals in different stages of pregnancy/parenthood.

It should be further noted that as a result of this process, a single edition of a magazine (e.g., for a first trimester pregnancy) may be sent in multiple distinctly different mailing periods for receipt by different subscribers at distinctly different times. In other words, copies of a particular edition/issue are sent asynchronously.

The present invention provides for systematic use of multiple sequential issues for each edition of a magazine. This allows for distribution of time-sensitive information in a time-appropriate manner. As discussed above, a issue schedule is established during the planning process discussed above with reference to FIG. 1. The issue schedule is a predetermined schedule that indicates the dates during which each issue of each edition is intended to be available for distribution, i.e. the “current” issue/edition as of a particular date.

Each issue is customized for a respective period in a continuum of time. Accordingly, for example, a 2005 issue of a particular edition (first trimester pregnancy) may include advertisements for products sold in 2005, and a 2006 issue of the same edition may include advertisements for products sold in 2006. Accordingly, the appropriateness of issues is closely tied to a continuum of time, whereas the appropriateness of editions is decoupled from the continuum of time; instead, the appropriateness of editions is closely tied to an individual subscriber's present stage in a process.

Due to the decoupling of editions from the time spectrum, the circulation of issues can be managed. For example, the issue schedule can be modified so that a particular issue of an edition can be held current for an extended period of time than previously established on the issue schedule.

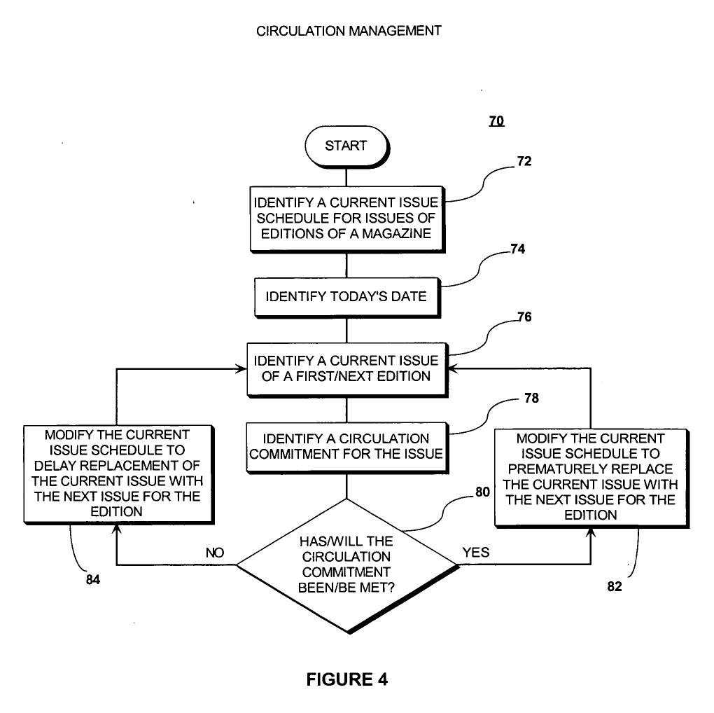

FIG. 4 is a flow diagram 70 illustrating exemplary management of the circulation of individual issues of magazine editions, as shown at step 72. As shown in FIG. 4, the method begins with identifying a issue schedule for issues of editions of the magazine. An exemplary issue schedule is shown in FIG. 6.

Next, a date is identified for reference purposes, the present date being identified in the example of FIG. 4, as shown at step 74 and discussed above with reference to FIG. 2. An iterative process then begins in which a current issue of a first (or next) edition is identified as shown at step 76, e.g. Issue 1 (I1) of Edition 1 (E1), as shown in FIG. 6.

A circulation commitment is then identified for that particular issue, as shown at step 78, e.g., by referencing a database storing such information. By way of example, a circulation commitment may be established by selling to an advertiser an advertising commitment that involves distribution of 500,000 copies of a magazine including the advertiser's advertisement.

Alternatively, the number of printed copies of a particular issue may be treated as the circulation commitment. This information may be advantageous, for example, to exhaust an existing inventory of pre-printed copies of a particular issue of a particular edition. The use of existing inventory reduces waste and corresponding costs.

It is then determined whether the circulation commitment has been met, as shown at step 80. If the circulation commitment has been met (or is forecasted to be met in consideration of the issue schedule), e.g. if the circulation commitment for an issue is 500,000 copies and 500,000 copies of that issue have been distributed, then the issue schedule may be modified to prematurely replace the current issue (e.g. I1) with the next issue (e.g., I2) for a particular edition (e.g., E1), as shown at steps 80 and 82. This may be advantageous, for example, when an advertising commitment has been met earlier than originally planned, thereby providing an opportunity to sell and/or collect revenues on additional advertising space in a subsequent issue. The current issue of the next edition is then considered, as shown in steps 82 and 76.

If it is determined that the circulation commitment has not been met (or will not be met during according to the issue schedule) in step 80, then the issue schedule may be modified to delay replacement of the current issue with the next issue for a particular edition, as shown at step 84. Alternatively, or additionally, the stage ranges of the editions may be modified to overlap, or to have greater overlap, to result in distribution of a greater number of issues. This may be advantageous, for example, to hold as current for an extended period and keep delivering a particular issue when an advertising commitment has not yet been met in order to meet an advertising commitment. This is not possible in the conventional magazine context which is closely linked to time; instead it is necessary, for example, to distribute the April issue in April and the May issue in May, etc. The current issue of the next edition is then considered, as shown at steps 84 and 76.

This circulation management method may be repeated periodically.

There are substantial inventory costs involved with printing and warehousing copies of physical objects, such as printed magazines. Inventory costs may be managed to reduce waste by determining with precision an appropriate number of copies of each issue to print for each edition. This can be determined with accuracy by considering not only the number of subscribers, an estimate of possible new subscribers, and an estimate of possible lost subscribers, but also by considering which of the present subscribers will qualify in the future for a particular edition during the period of that it will be available. The careful determination of a required inventory reduces waste and corresponding costs.

FIG. 5 is a flow diagram 90 illustrating exemplary inventory management for an individual issue of an individual edition of a magazine. The method may be repeated for each edition and issue. As shown in FIG. 5, the method begins with identification of subscribers, each of which is presently at a respective state of a process, as shown at step 92. In the example above, each subscriber has provided during a subscription process information for determining when each subscriber is at each of the stages.

Next, a stage range of the edition is identified, as shown at step 94. For example, the stage range may be for children aged 0-3 months. A period during which the edition's next issue will be current is then determined, as shown at step 96. For example, it may be determined that the next issue (I2) of Edition 3 (E3) in the example of FIG. 6 will be current from Aug. 15, 2006 until Feb. 15, 2007.

It is then determined how many subscribers will be at a stage within the stage range during the current issue period, as shown at step 98. This determination of stage may be performed by comparing date information, stage information, personal information relating to the subscriber, as discussed above with reference to step 28 of FIG. 2. However, this determination must also account for the future dates corresponding to the current issue period, so that subscribers are at a stage within the stage range for an edition during the edition's current issue's period. This forecast may be further refined by estimating a number of new subscriptions and their respective stage-relevancies, and by estimating a number of cancellations, e.g. due to a miscarriage, wedding date cancellations, rescheduling of a surgical procedure, etc.

A number of copies of the issue of the edition that corresponds to the number of such subscribers is then printed. This number may be identical to the number determined above, or may also account for additional copies in case of loss/damage, to account for new subscribers, or account for loss of subscribers, etc. These copies will then serve as the inventory of copies to be sent over the coming months to subscribers who are in or who enter the stage range during the current issue period. It is notable that this number does not correspond in a direct and straightforward way to the total number of subscribers. Instead, the calculation depends upon stage-related information and issue period information.

It will be appreciated that various modifications may be made to the example described above. By way of example, a “versioning” technique used for print media may be adapted for use in accordance with the present invention. As known in the art, versioning allows for mass customization, or personal customization, of individual magazine issues as they are bound during the printing/production process, e.g. to include a particular advertisement targeted to a particular recipient, or class of recipients. In such an event, not all copies of a particular issue of a particular edition would be identical. Instead, there would be some variation among the copies of a particular issue of a particular edition. Further, versioning may be used to produce “sub-editions,” such as a twins-related edition for a particular stage. Delivery of such a sub-edition may be triggered by the personal information.

### COMPUTER PLATFORM

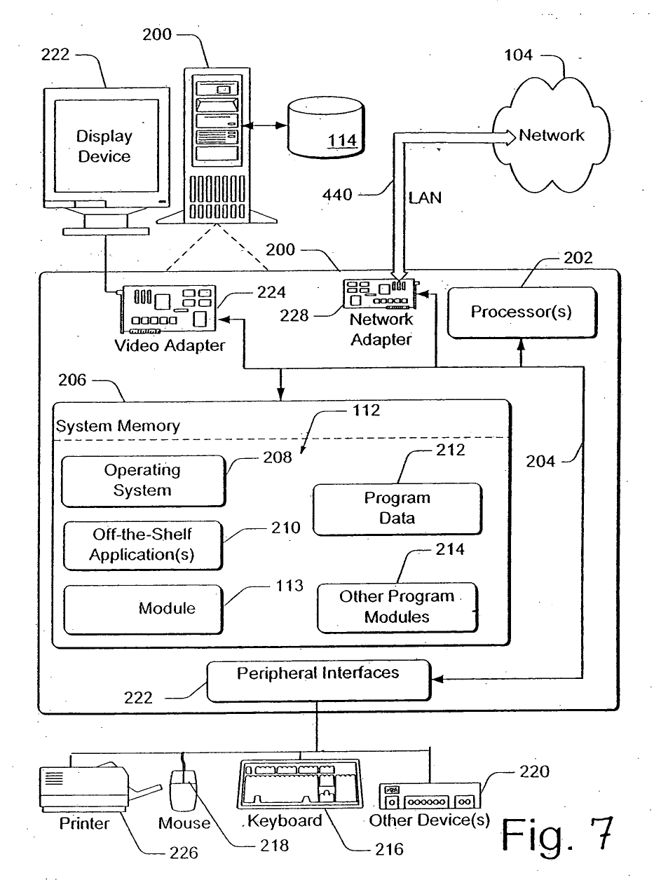

FIG. 7 is a block diagram showing an example computer 200 within which various functionalities described herein can be fully or partially implemented. Computer 200 can function as a server, a personal computer, a mainframe, or various other types of computing devices. It is noted that computer 200 is only one example of computer environment and is not intended to suggest any limitation as the scope or use or functionality of the computer and network architectures. Neither should the example computer be interpreted as having any dependency or requirement relating to any one or combination of components illustrated in FIG. 7.

Computer 200 may include one or more processors 202 coupled to a bus 204. Bus 204 represents one or more of any variety of bus structures and architectures and may also include one or more point-to-point connections.

Computer 200 may also include or have access to memory 206, which represents a variety of computer readable media. Such media can be any available media that is accessible by processor(s) 202 and includes both volatile and non-volatile media, removable and non-removable media. For instance, memory 206 may include computer readable media in the form of volatile memory, such as random access memory (RAM) and/or non-volatile memory in the form of read only memory (ROM). In terms of removable/non-removable storage media or memory media, memory 206 may include a hard disk, a magnetic disk, a floppy disk, an optical disk drive, CD-ROM, flash memory, etc.

Any number of program modules 112 can be stored in memory 206, including by way of example, an operating system 208, off-the-shelf applications 210 (such as e-mail programs, browsers, etc.), program data 212, the software application at least partially implementing the present invention being referred to as reference number 113 in FIG. 7, and other modules 214. Memory 206 may also include one or more persistent stores 114 containing data and information enabling functionality associated with program modules 112.

A user can enter commands and information into computer 200 via input devices such as a keyboard 216 and a pointing device 218 (e.g., a “mouse”). Other device(s) 220 (not shown specifically) may include a microphone, joystick, game pad, serial port, etc. These and other input devices are connected to bus 204 via peripheral interfaces 222, such as a parallel port, game port, universal serial bus (USB), etc.

A display device 222 can also be connected to computer 200 via an interface, such as video adapter 224. In addition to display device 222, other output peripheral devices can include components such as speakers (not shown), or a printer 226.

Computer 200 can operate in a networked environment or point-to-point environment, using logical connections to one or more remote computers. The remote computers may be personal computers, servers, routers, or peer devices. A network interface adapter 228 may provide access to network 104, such as when network is implemented as a local area network (LAN), or wide area network (WAN), etc.

In a network environment, some or all of the program modules 112 executed by computer 200 may be retrieved from another computing device coupled to the network. For purposes of illustration, the operating program module 113 and other executable program components, such as the operating system, are illustrated herein as discrete blocks, although it is recognized that such programs and components reside at various times in different storage components remote or local, and are executed by processor(s) 202 of computer 200 or remote computers.

### PROGRAM MODULE

Techniques and functionality described herein may be provided in the general context of computer-executable instructions, such as program modules, executed by one or more computers (one or more processors) or other devices. Generally, program modules include routines, programs, objects, components, data structures, logic, etc. that perform particular tasks or implement particular abstract data types. Typically, the functionality of the program modules may be combined or distributed as desired in various embodiments, to carry out one or more of the methods, or combinations of steps of the methods, described herein. It is noted that a portion of a program module may reside on one or more computers operating in a system.

An implementation of these modules and techniques may be stored on or transmitted across some form of computer readable media. Computer readable media can be any available media that can be accessed by a computer. By way of example, and not limitation, computer readable media may comprise volatile and non-volatile media, or technology for storing computer readable instructions, data structures, program modules, or other data.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A method for distributing information in printed format, the method comprising:
defining an issue schedule for sequential issues of a physical print media publication, each issue including information content customized for a particular period in a continuum of time, the issue schedule providing that each issue shall be distributed for a specified period of time;
identifying a date;
referencing the issue schedule to determine which of the sequential issues shall be circulated for the date; and
modifying the issue schedule to extend or contract the specified period of time that a particular issue shall be circulated, the particular issue being that issue that shall be circulated for the date.

2. The method of claim 1, further comprising:
identifying a circulation commitment for the particular issue; and
determining whether the circulation commitment has been met for the particular issue;
wherein the issue schedule is modified to reflect whether the circulation commitment has been met.

3. The method of claim 1, further comprising:
identifying a remaining inventory of the particular issue that will remain if circulation of the particular issue is terminated at the end of the period of time;
wherein the issue schedule is modified to extend the period of time and cause circulation of additional copies of the particular issue from the remaining inventory.

4. The method of claim 1, wherein modifying the issue schedule comprises:
modifying the issue schedule to advance the date on which circulation of the particular issue will be replaced by circulation of a next sequential one of the sequential issues.

5. The method of claim 4, further comprising:
sending to subscribers copies of the particular issue according to the modified issue schedule.

6. The method of claim 4, wherein the issue schedule provides that each of the sequential issues will be circulated from a respective starting date to a respective ending date.

7. The method of claim 6, wherein modifying the issue schedule comprises replacing the respective ending date with a modified ending date that is earlier in time than the respective ending date.

8. The method of claim 7, further comprising:
sending to subscribers copies of the particular issue until the modified ending date; and
sending to subscribers copies of a next sequential one of the sequential issues after the modified ending date.

9. The method of claim 1, wherein modifying the issue schedule comprises:
modifying the issue schedule to delay the date on which circulation of the particular issue will be replaced by circulation of a next sequential one of the sequential issues.

10. The method of claim 9, further comprising:
sending to subscribers copies of the particular issue according to the modified issue schedule.

11. The method of claim 9, wherein the issue schedule provides that each issue will be circulated from a respective starting date to a respective ending date.

12. The method of claim 11, wherein modifying the issue schedule comprises replacing the respective ending date with a modified ending date that is later in time than the respective ending date.

13. A method for distributing information relating to a process, the method comprising:
defining an issue schedule for sequential issues of at least one edition of a physical print media publication, the edition including information content relating to a range of multiple ones of a plurality of sequential stages of a process, each issue including information content customized to a particular period in a continuum of time, the issue schedule providing that a respective one of the sequential issues will be circulated for a period of time extending from a respective starting date to a respective ending date;
identifying a date;
referencing the issue schedule to determine which of the sequential issues is shall be circulated for the date;
identifying a circulation commitment for a particular issue to be circulated for the date;
determining whether the circulation commitment has been met for the particular issue; and
modifying the issue schedule extend or contract the period of time to reflect whether the circulation commitment has been met.

14. The method of claim 13, wherein modifying the issue schedule comprises replacing the respective ending date with a modified ending date that is earlier in time than the respective ending date.

15. The method of claim 13, wherein modifying the issue schedule comprises replacing the respective ending date with a modified ending date that is later in time than the respective ending date.

16. The method of claim 13, wherein the issue schedule provides that only the respective one of the sequential issues will be circulated for the period of time.

17. A method for distributing information, the method comprising:
defining an issue schedule for sequential issues of a physical print media publication, each issue including information content customized to a particular period in a continuum of time, the issue schedule providing that a respective one of the sequential issues will be circulated from a respective starting date to a respective ending date;
identifying a circulation date;
referencing the issue schedule to determine which of the sequential issues shall be circulated for the date; and
for a particular issue to be circulated as of the circulation date, modifying the issue schedule to replace the respective ending date with a modified ending date, the modified ending date being later in time than the respective ending date if the circulation commitment has not been met, the modified ending date being earlier in time than the respective ending date if the circulation commitment has been met.

18. The method of claim 17, wherein the determination of whether the circulation commitment has been met is estimated as of the circulation date.

19. The method of claim 17, wherein the determination of whether the circulation commitment has been met is made as of the respective ending date.

20. The method of claim 17, wherein the issue schedule provides that only the respective one of the sequential issues will be circulated for the period of time.

21. A method for distributing information, the method comprising:
defining an issue schedule for sequential issues of a physical print media publication, each issue including information content customized to a particular period in a continuum of time, the issue schedule providing that a respective one of the sequential issues shall be circulated from a respective starting date to a respective ending date;
identifying a circulation date;
referencing the issue schedule to determine which of the sequential issue is current as of the date; and
for a particular issue to be circulated as of the circulation date, modifying the issue schedule to replace the respective ending date with a modified ending date, the modified ending date being later in time than the respective ending date if an inventory of the particular issue is expected to remain after the respective ending date, the modified ending date being earlier in time than the respective ending date if an inventory of the particular issue is not expected to remain after the respective ending date.

22. The method of claim 21, wherein the issue schedule provides that only the respective one of the sequential issues will be circulated for the period of time.

23. A system for distributing information, the system comprising:
a processor;
a memory operably connected to the processor; and
instructions stored in the memory and executable by the processor to cause said system to carry out the method of claim 1.

24. A system for distributing information, the system comprising:
a processor;
a memory operably connected to the processor; and
instructions stored in the memory and executable by the processor to cause said system to carry out the method of claim 13.

25. A system for distributing information, the system comprising:
a processor;
a memory operably connected to the processor; and
instructions stored in the memory and executable by the processor to cause said system to carry out the method of claim 17.

26. A system for distributing information, the system comprising:
a processor;
a memory operably connected to the processor; and
instructions stored in the memory and executable by the processor to cause said system to carry out the method of claim 21.

27. A computer program product embodied on one or more computer-readable media, the computer program product comprising computer readable program code configured to carry out the method of claim 1.

28. A computer program product embodied on one or more computer-readable media, the computer program product comprising computer readable program code configured to carry out the method of claim 13.

29. A computer program product embodied on one or more computer-readable media, the computer program product comprising computer readable program code configured to carry out the method of claim 17.

30. A computer program product embodied on one or more computer-readable media, the computer program product comprising computer readable program code configured to carry out the method of claim 21.
